(19) United States
(12) Patent Application Publication
(10) Pub. No.: US 2020/0391295 A1
(43) Pub. Date: Dec. 17, 2020

(54) METHOD AND APPARATUS FOR PRODUCING FINE SPHERICAL POWDERS FROM COARSE AND ANGULAR POWDER FEED MATERIAL

(71) Applicant: PYROGENESIS CANADA INC., Montreal (CA)

(72) Inventors: Christopher Alex DORVAL DION, Montreal (CA); Ali SHAHVERDI, Verdun (CA); François PROULX, Montreal (CA)

(21) Appl. No.: 16/764,344

(22) PCT Filed: Nov. 14, 2018
(86) PCT No.: PCT/CA2018/000225

§ 371 Date: May 14, 2020

Related U.S. Application Data
(60) Provisional application No. 62/585,882, filed on Nov. 14, 2017.

(51) Int. Cl. B22F 9/08; B22F 1/00; B33Y 70/00

(52) U.S. Cl. CPC B22F 9/082; B22F 1/0048; B33Y 70/00; C22C 1/0458; B22F 2202/13; B22F 2998/10; B22F 2009/088

(57) ABSTRACT

A high temperature process is provided, which can melt, atomize and spheroidize a coarse angular powder into a fine and spherical one, it uses thermal plasma to melt the particle in a heating chamber and a supersonic nozzle to accelerate the stream and break up the particles into finer ones.

### CROSS REFERENCE TO RELATED APPLICATIONS

This Application claims priority on U.S. Provisional Application No. 62/585,882, now pending, filed on Nov. 14, 2017, which is herein incorporated by reference.

### FIELD

The present subject matter relates to the fabrication of spherical powders that can be used for demanding applications in Additive Manufacturing, such as Metal Injection Molding and 3D printing, from available and affordable coarse and angular feed stock material. More specifically, the present subject matter is concerned with processes that can produce fine spherical powders.via plasma processing.

### BACKGROUND

There is a high demand on the market for powders that are both fine and spherical. Methods to produce such powders tend to either use expensive source feedstock, such as a wire, or tend to have very low yield in the desirable range (5-45 microns).

Spherical powders exhibit superior suitability for many applications compared to their angular counterparts, mainly due to their higher density and better flowability and better resistance to attrition.

Coarse and angular powders in the 106-150 microns can easily be produced at low cost and are readily available on the market.

Processes that are capable of spheroidizing powders already exists, but it is believed that no current process can both atomize and spheroidize particles to fall into the desirable ranges used in additive manufacturing (5-20, 15-45 and 20-53 microns, as example). By the term “atomization”, a particle size reduction that involves a mechanical break up of a molten particle into two or more droplets is meant. This term excludes the size reduction due to changes in form factor only (for example, passing from a porous and angular particle to a denser and spherical particle, herein called “spheroidization”) or synthesis of a particle that goes through a vaporization step followed by a resolidification step.

Processes to reduce the particle size by vaporizing the powder and condensing it back into solid fine powders, such as in the case of nanoparticle synthesis, do exist but possess considerable drawbacks. First, the resulting powder is usually in the nanometric range, which is generally too fine for the state of the art in additive manufacturing. Secondly, vaporizing the powder requires higher residence time and higher power load, which translates into low production rates and high process costs. Finally, the vaporization way is only applicable for pure compounds that do not degrade before vaporizing, which is an extremely limiting consideration. This means that alloys cannot be reliably produced using that route, as the elements present in the mixture will evaporate and condense at different rates. It also limits the compounds that can be processed, as some compounds will degrade due to temperature before reaching the boiling point.

Processes to treat angular powders into spherical powders do exist as well. Spheroidization works by melting the particle, or at least its surface, to smooth out the edges, to reach the most stable and compact form factor which is a sphere. However, this method does not change significantly the particle size of the powder unless the powder feedstock is highly angular and porous. This process involves no particle break up. This means that if one aims for a fine powder as a final product, the powder feedstock going into the spheroidization process must already meet the desired particle size distribution. While this can work for highly chemically stable compounds such as oxide ceramics, for other materials, such as metal, this will generally result in powders having higher oxygen contents than tolerable for the desired application. The reason for this is that an angular powder normally goes through a mechanical size reduction process to reach the target particle size distribution, which implies a high level of friction thereby causing a significant elevation of temperature. Even under controlled atmosphere, the metal powder, if milled to very fine particle size, is likely to pick up a significant amount of oxygen in the process. The spheroidization process also causes oxygen pick up, which means the total amount of oxygen picked up can exceed the maximum tolerance specified by a standard.

Moreover, prior spheroidization methods often include the usage of an inductively coupled plasma source, which requires a radio frequency induction power supply, which is highly specific and rarely available commercially.

It is also interesting to point out that plasma atomization is believed to currently be the process that produces the most spherical and dense powders available on the market. This technology also produces a narrow particle size in the finer range, which is highly desirable for the Additive Manufacturing field. One of the major limitations of this technology is that it typically can process only wire as a feed stock. This is a significant limitation considering that some valuable in-demand materials, such Titanium Aluminide (TiAl), carbides and ceramics, are difficult to be sourced as a wire due to their mechanical properties but are readily available in powder form. No plasma atomization process using powder as a feedstock is believed to currently exist.

Gas atomization typically uses melted ingots for atomization. However, this technology also possesses several limitations. First, it results in particles that contain porosity due to gas entrapment. Second, and most importantly, the particle size distribution is typically wide. It is important to mention that gas atomization cannot currently be used to re-process coarse powders.

Coarse powders (106 microns and above, for example), spherical or not, are typical by-products of most atomization technologies and have very low value on the market compared to the finer cuts. It could be economically beneficial to use this powder source as a feedstock in a process that can re-atomize this powder into finer particles, and therefore increasing its value. Moreover, if this powder feedstock turns out to be angular or is highly porous, the added benefit spheroidization in the same process would indeed increase its value furthermore.

### SUMMARY

It would therefore be desirable to provide a process that produces spherical, highly dense, fine powders from a mechanically produced, angular, coarse powder feedstock.

It would also be desirable to have a low cost process that uses a widely available and reliable commercial DC plasma cutting power supply and a DC plasma torch, rather than custom, high cost high frequency induction power supplies and ICP torches.

The embodiments described herein provide in one aspect a process for spheroidizing and/or atomizing particles that are coarse and/or angular into spherical and fine particles, comprising: a heating source, a heating chamber, a supersonic nozzle, and a gas-solid separation system to collect the powder from the gas stream.

Also, the embodiments described herein provide in another aspect an apparatus for spheroidizing and/or atomizing particles that are coarse and/or angular into spherical and fine particles, comprising: a heating source, a heating chamber, a supersonic nozzle, and a gas-solid separation system to collect the powder from the gas stream.

Furthermore, the embodiments described herein provide in another aspect a process for spheroidizing and/or atomizing feedstock particles that are coarse and/or angular into spherical and fine particles, comprising: a) heating the feedstock particles, b) having the particles go through a supersonic nozzle, and c) collecting from the gas stream a so-produced powder, for instance with a gas-solid separation system.

### BRIEF DESCRIPTION OF THE DRAWINGS

For a better understanding of the embodiments described herein and to show more clearly how they may be carried into effect, reference will now be made, by way of example only, to the accompanying drawings, which show at least one exemplary embodiment, and in which:

FIG. 1 is a schematic front elevation view of an apparatus for producing fine spherical powders from coarse and angular powder feed material in accordance with an exemplary embodiment;

FIG. 2 is a schematic representation of a melting zone and an atomization section of the apparatus of FIG. 1 in accordance with an exemplary embodiment;

FIG. 3 is a schematic cross-sectional view showing an example of a convergent-divergent nozzle (e.g. a De-Laval nozzle) of the apparatus of FIG. 1 in accordance with an exemplary embodiment;

FIGS. 4A and 4B are Scanning Electron Microscopy (SEM) pictures of a powder respectively before and after processing through the apparatus shown in FIG. 1 in accordance with an exemplary embodiment;

FIG. 5 shows another SEM picture of the same powder sample illustrated in FIG. 4B, but at a larger zoom;

FIGS. 6A and 6B show a laser diffraction Particle Size Distribution (PSD) for a same sample respectively before and after processing and correspond to the same samples shown in FIGS. 4A and 4B, and in the same order in accordance with an exemplary embodiment; and

FIGS. 7A, 7B and 7C illustrate variants of a heating chamber with a De Laval nozzle in accordance with an exemplary embodiment.

### DESCRIPTION OF VARIOUS EMBODIMENTS

The current subject matter is directed to a high temperature process (and apparatus) that can melt, atomize and spheroidize a coarse angular powder into a fine and spherical one. It could be described either as a plasma atomization process using a powder feedstock or as a powder spheroidization technology that includes a particle break up feature.

This current subject matter can accomplish a size reduction of particles via both atomization and spheroidization but does not involve vaporization (or is at least not considered as a significant contributor to the size reduction).

Gas atomizer users would benefit from a powder re-atomization technology that converts the coarse powders produced by the technology to fine powders suitable for additive manufacturing.

Herein, the coarse angular powder is fed into a plasma reactor where it will be in contact with a plasma jet for a long enough period to reach its melting point and melt at least partially. The chamber length is thus a function of the desired feed rate and selected material. The melted liquid particles are then introduced into a De Laval nozzle, where the plasma or hot gas will be accelerated to supersonic velocities over a very short distance (in the order of magnitude of an inch). Due to the enormous velocity difference between the melted droplet and the plasma or hot gas stream, the droplet is sheared until it reaches its break-up point. At this point, the droplet collapses into two or more finer particles. As the droplets are ejected from the De Laval nozzle into a cooling chamber, the droplets can reach the form factor minimizing the surface energy, which is the sphere, and freeze back to solid.

The hot zone prior to the De Laval nozzle is designed to provide a high enough temperature and residence time to not only bring the particle to its melting point but also to melt it.

The De Laval nozzle must be carefully designed to reach the right temperature and velocity combination at the throat and in the jet exiting the nozzle for a specific set of process parameters such gas flow and torch power. The nozzle is used to convert thermal energy into kinetic energy. It should be designed for its acceleration to be sufficient to cause particle break up while keeping the temperature above the melting point of the atomized material.

The outlet of the De Laval nozzle can include a diffuser, which does essentially the opposite of what a De Laval nozzle does, in that it forces the gas and the particle to slow down abruptly, re-increasing the temperature drastically to near what it was before the De Laval nozzle. The diffuser will also have the effect of rising the particle temperature, which can help to keep the droplet above its melting point after the acceleration described above and therefore avoid the formation of stalactites at the exit of the nozzle.

The design of the De Laval nozzle and its diffuser impacts on the size and the distribution of the powder produced, as well as the maximal particle loading that can be processed.

After the nozzle, during the cool down in the cooling zone, the atomized droplets must reach their ideal form (a sphere) prior to reaching their solidification temperature. Once the ideal form factor is reached, the particle can freeze to solid state. This step can be conducted in a cooling tower, which can consist, for example, of a larger diameter cylinder with a water-cooling jacket.

The cooling tower should provide residence time long enough so that the particles have at least a thick enough solidified shell (if not completely solidified) to protect them from changing shape before entering in contact with other solid materials during the subsequent steps of the process. The dimensions of the cooling tower are determined by the requirements of the process, such as the selected feedstock, the desired feed rate and the plasma torch's flow rate. Such solid materials can be the reactor and piping walls or other particles.

At this stage, the particles can be collected, either at the bottom of the apparatus, or conveyed pneumatically to a conventional powder collection device, such as, but not restricted to, a cyclone, a filter, or a settling chamber. Preferably, the particles must be collected cold enough to reduce oxidation before being put in contact with ambient air.

Once the powders are collected and separated from the gas stream, the gas stream can be filtered furthermore to ensure that no powder is sent to the exhaust.

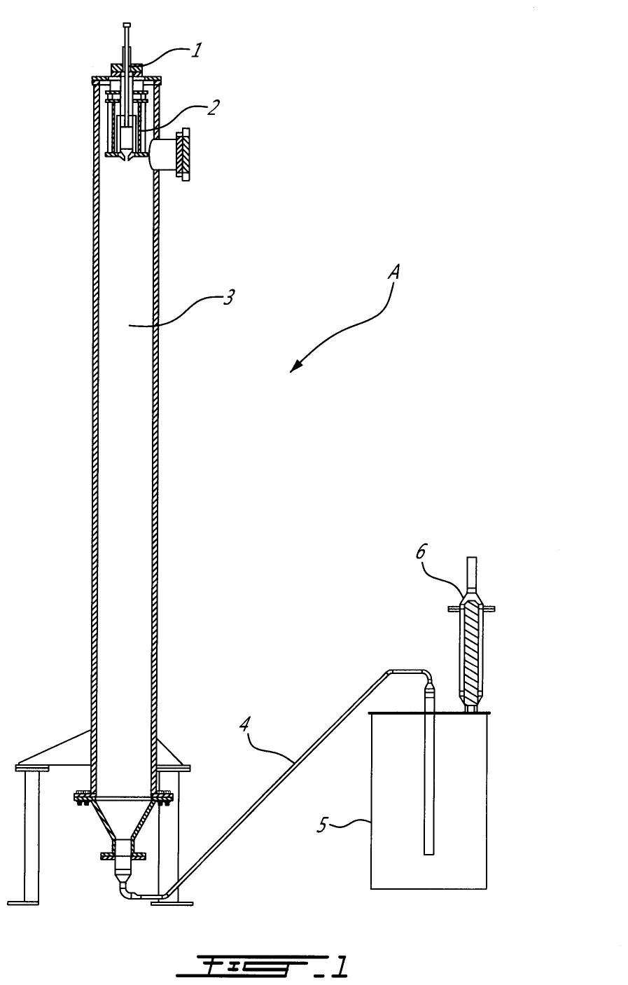

Now referring to the appended drawings, FIG. 1 depicts a schematic representation of an apparatus A in accordance with the current subject matter. The apparatus A includes a plasma torch 1, a heating chamber with a De Laval nozzle 2, a cooling chamber 3, a transfer tube 4 in which the powder is carried pneumatically to a settling chamber 5, and finally a porous metal filter 6. This is only an example of various possible embodiments.

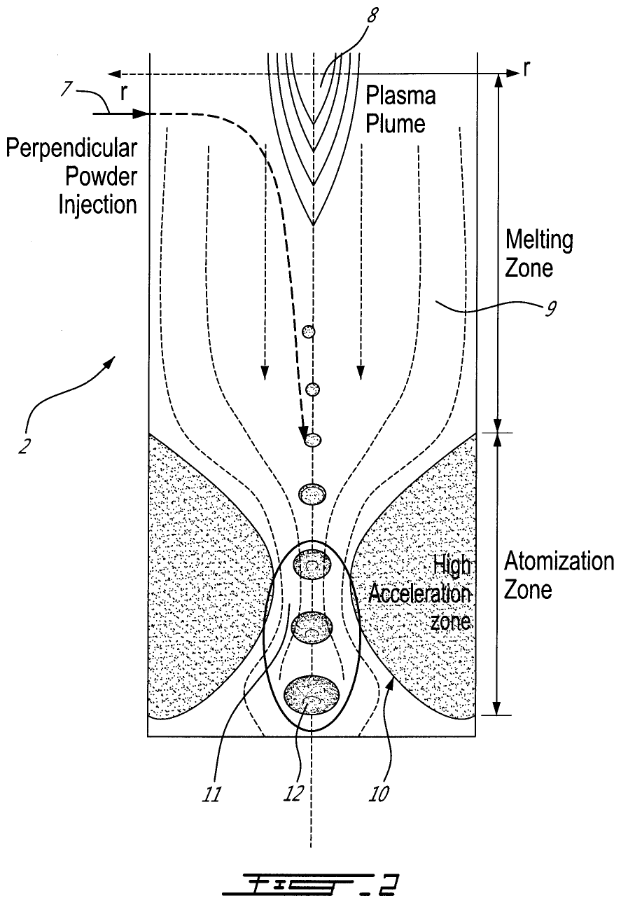

FIG. 2 shows conceptually how the core element 2 of the present subject matter works. This section is a conceptual representation of the De Laval nozzle of FIG. 1. In this example, the powder feed stock is fed at 7 perpendicularly to a plasma jet 8 (although it could have been fed co-current, counterflow or with an angle). As the particle gets carried in a heating zone 9, it reaches its melting point and starts to melt. Once melted, as the hot gas or plasma is accelerated, the particle starts to deform to take the shape of a thin disk. Further down, as the particle reaches a throat 11 of the De Laval nozzle 10, the particle burst into multiple finer particles. An exiting stream 12 is a mixture of hot gas and fine particles, which enters the cooling chamber 3.

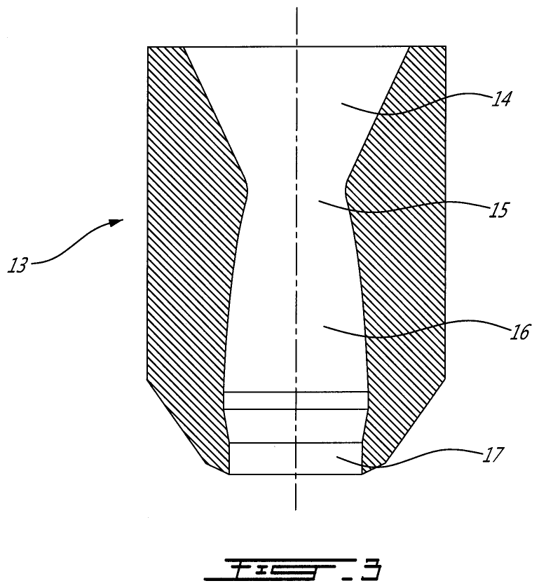

FIG. 3 shows one example of a viable design for the nozzle. In this example, a nozzle 13 includes, from top to bottom, a convergent section 14 where the fluid is to be accelerated, a throat 15 where the fluid is to reach the speed of sound (Mach number=1), a divergent section 16 where the fluid exceeds the speed of sound (Mach number>1), and finally a diffuser 17, where kinetic energy is re-converted to thermal energy to increase the temperature before the exit (Mach number<1). A more simplistic example would be the classic Convergent-Divergent De-Laval nozzle, a case that was used for most experiments for the present subject matter.

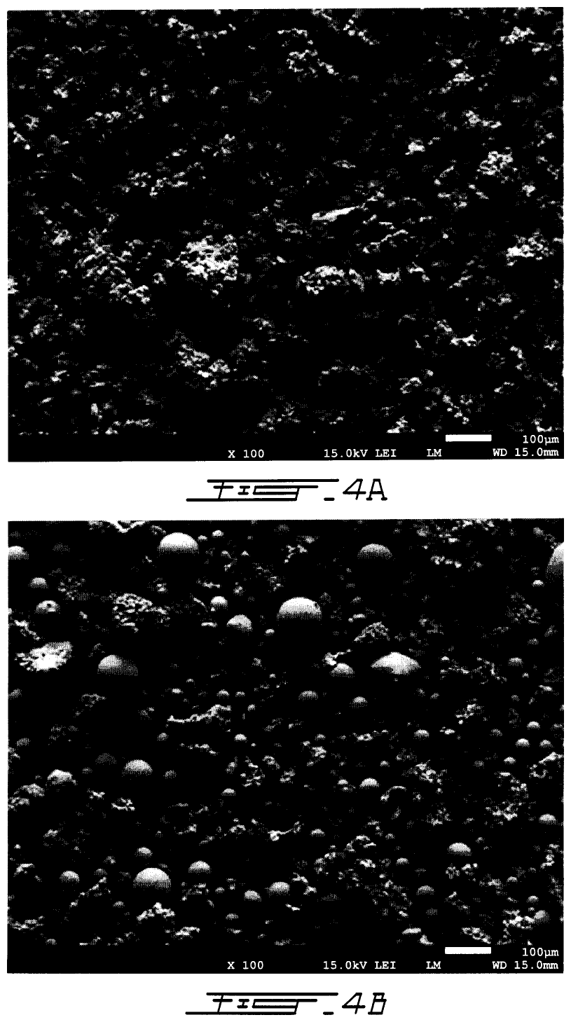

FIGS. 4A and 4B are Scanning Electron Microscopy (SEM) pictures of the powder before and after processing through the embodiment shown in FIG. 1, respectively. In FIG. 4A, one can see that the powder is made exclusively of angular and porous powder. In FIG. 4B, after processing, although not all the powder, a considerable amount of the powder is spherical. Both pictures were taken with the same zoom (×100) and therefore can be used for comparison purposes. To a trained eye, it is visually noticeable that the particles are generally smaller in FIG. 4B than in FIG. 4A.

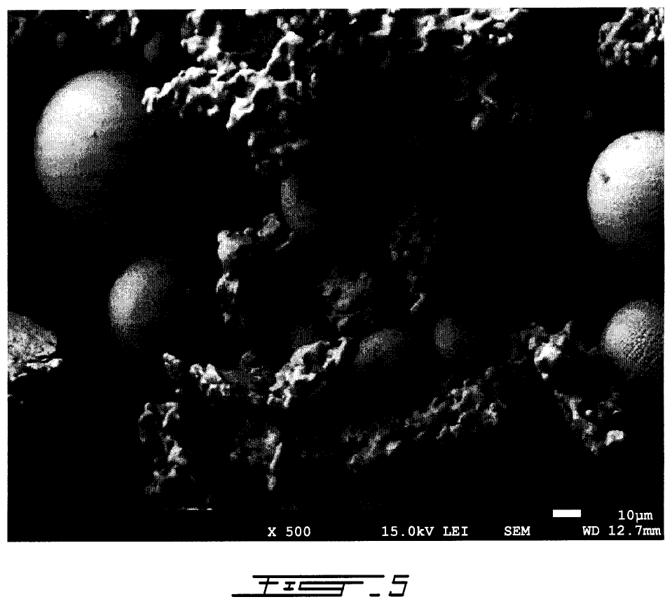

FIG. 5 shows another SEM picture of the same powder sample than in FIG. 4B, but at larger zoom (×500). From this figure, someone knowledgeable in the field could assess that: 1) the powder that has been spheroidized has a very high degree of sphericity; 2) the satellite (ultrafine particles welded on larger particles) content is very low, and 3) the powder that was not spheroidized has at least somewhat softened edges, which could nevertheless help with flowability.

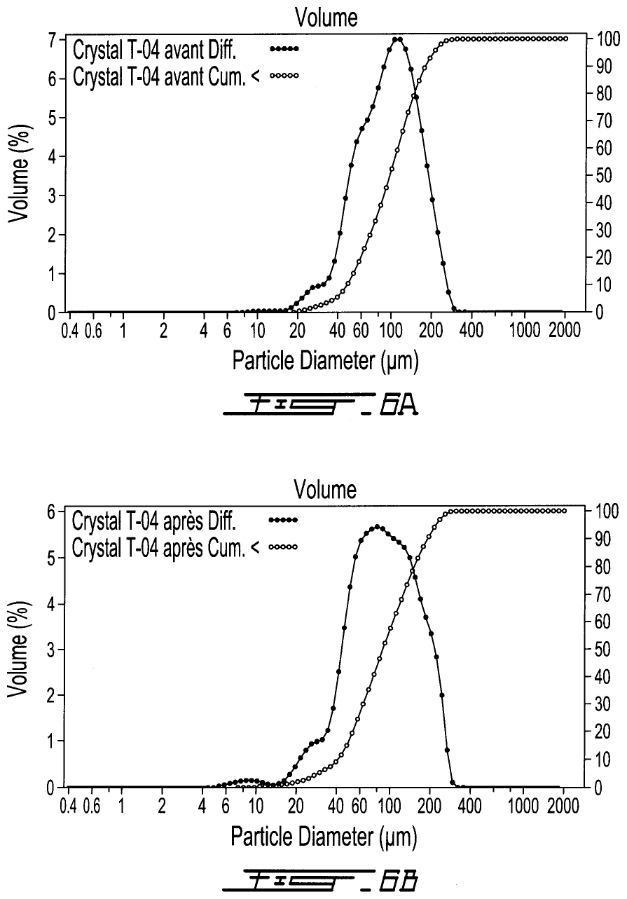

FIGS. 6A and 6B show the laser diffraction particle size distribution (PSD) for both same sample respectively before and after processing and correspond to the same samples shown in FIGS. 4A and 4B, and in the same order. A significant particle size shift towards the finer side is noticeable between FIGS. 6A and 6B. The median particle size (D50) is 12 microns lower in FIG. 6B than in FIG. 6A, which is quite significant considering that only a portion of the powder was melted. When compared with what can be found in literature, this particle shift is too significant to be attributed to spheroidization only, which indicates that indeed particle break up took place at least partially.

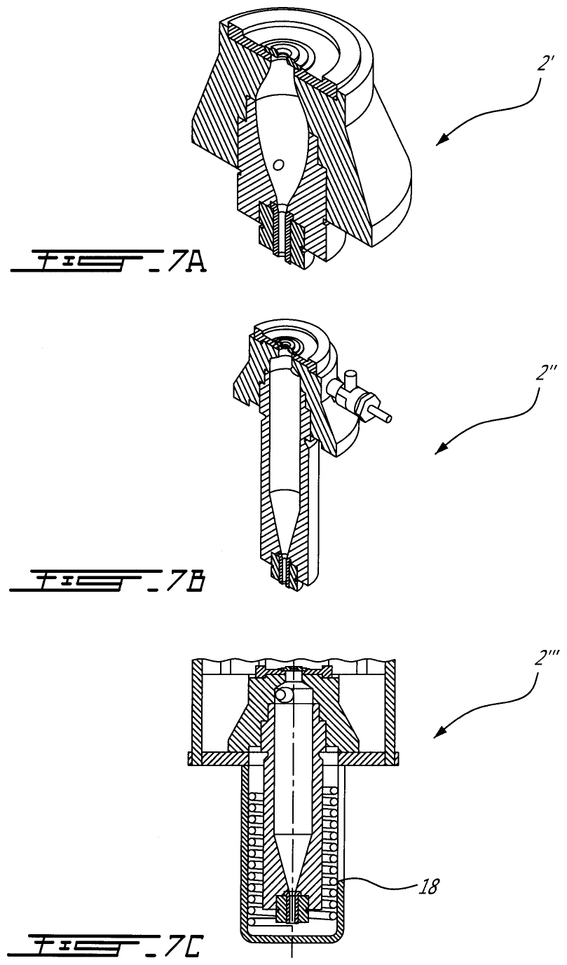

FIGS. 7A, 7B and 7C show some variants that were tried experimentally of the heating chamber with De Laval nozzle, which correspond to item 2 in FIG. 1. In FIG. 7A, there is shown a heating chamber with De Laval nozzle 2′, which represents a graphite chamber with the shape of a bulb, where the powder is fed counterflow with an angle of 45 degrees. In FIG. 7B, there is shown a heating chamber with De Laval nozzle 2′, wherein the chamber is elongated, and the powder is fed perpendicularly to the plasma jet. In FIG. 7C, there is shown a heating chamber with De Laval nozzle 2′″, which includes an induction coil 18 to the configuration shown in FIG. 7B in order to increase the wall temperature and therefore reduce the heat losses. While all three configurations worked to some degree, the results presented herein were produced with the configuration shown in FIG. 7A.

Therefore, the current subject matter, as a process, includes the following elements: a heating source such as a plasma source, a heating chamber, an accelerating (e.g. supersonic) nozzle, a cooling chamber and a powder collection system. All these elements are further described hereinbelow.

It is noted that the plasma source is a DC arc plasma torch, either reversed or straight polarity. However, any other source of thermal plasma could work, including AC arc or RF inductively-coupled. The experimental results reported herein were obtained using a reversed polarity plasma torch that was selected due to its high enthalpy plasma plume, but it could be replaced by other plasma torch models. Straight-polarity DC arc plasma torches were also tried and gave similar results. Plasma torches are suitable for this application due to their high plume temperature and nonreactive gas plume. For lower melting point materials and for materials where chemical contamination is not an issue, more affordable means of heating can be used, such as common gas burners.

As to the heating chamber, it is made of graphite or other high temperature material and has either a cylindrical or a bulb shape as shown in FIG. 7A. Graphite is an affordable and commonly available material that can sustain very high temperatures. Graphite can be easily machined using traditional methods and equipment, which makes it a material of choice for high temperature processes. For more robust and permanent installations, such as in the context of industrial production of high-quality materials, hard and high melting point materials, such as carbides and refractory materials, are more suitable for this application. It is to be noted that the walls of the hot zone and the De Laval nozzle must be hotter than the melting temperature of the treated material at all times.

At the bottom of the heating chamber, there is provided an accelerating nozzle. In the illustrated embodiment, this nozzle is either a classic converging-diverging De Laval nozzle 10 or a more complex nozzle design 13 as shown in FIG. 3. However, acceleration to supersonic velocities could be achieved via other nozzle designs, such as an aerospike configuration. The supersonic nozzle is designed so as to convert thermal energy into kinetic energy over a very short distance, while keeping the temperature of the fluid above the melting point of the processed material. It is the sudden acceleration of the plasma gas, which results in a high velocity difference with the particle, that causes the particle break up. As the De Laval nozzle converts heat to velocity, the process cools down the gas, whereby it might be necessary to add a source of heat at the exit of the nozzle. The required velocity difference between the droplets and the plasma stream to cause break up can be evaluated using the Weber number. For Weber numbers greater than 14, the droplet will most likely be atomized into finer droplets. The velocity difference between the particle and the plasma can be estimated using computational fluid dynamics modeling techniques.

The cooling chamber is typically a simple double jacket reactor with water cooling; however many other configurations would work just as well. The source of cooling is not as critical as long as the cooling is effective enough to cool the particles below their freezing point before they impact a solid wall. The required length of the cooling chamber is a function of the particle overheat, its heat of fusion, as well as the particle load. The diameter of the chamber will affect the velocity of the stream as well as the quality of the heat exchange, which therefore also affects the required length of the cooling chamber.

The powder collection system can be applied in many ways in practice. The main objective is to separate the powder from the gas stream to collect the powder continuously or semi-continuously, while the gas is expulsed continuously. In the embodiment that was tested experimentally, a settling chamber and porous metal filter were used to collect the powder and clean the gas stream. A more common way and proven method consists in providing a high efficiency cyclone followed by an HEPA filter or a wet scrubber. The powder collection is necessary, although the means to achieve it are not critical in the present context. For example, in FIG. 1, there is provided the porous metal filter 6 as a filtering element, which can be made of porous ceramics, porous metals, or by a conventional HEPA filter, as long as the filtering media can sustain the temperature of the exiting stream.

Although not shown in FIG. 1, the powder feedstock is fed to the apparatus using a powder feeder. The powder feeder is typically a commercial one used in the thermal spray industry. Several types exist and each of them have their advantages, drawbacks and limitations.

Possible Variants of the Methods

The particles can be fed counter-current or with any angle. Counter-current powder feed, although more difficult to achieve, will have the benefit of increasing the rate of heat transfer, and subsequently, significantly reduce the residence time required to melt the particle. This has for consequence of reducing the minimal hot zone length required.

Although the present subject matter is targeted at coarse and angular powders, it could also be used to breakup coarse non angular (spherical) powders into fine spherical particles.

Although, the current example uses plasma as a heat source, the heat source could be replaced by other types of heating, such as microwave, induction and such, as long as sufficient thermal power is provided.

The present subject matter was first developed with Titanium alloy powders; however, this could apply to any material that has a melting point reachable by the means of heating.

The present subject matter could also be used to produce nanoparticles. To do so, an even higher acceleration might be required. This would be advantageous as nanoparticles of alloy could be produced that way, whereas producing nanoparticles is not possible with the vaporization method.

Although not originally intended for, the present subject matter can also be used to purify the powders of its organic contaminant, as the high temperature of the plasma will degrade most undesired organic compound.

By adding a reducing agent such as hydrogen in the plasma gas, it is possible to not only process the material with minimum oxygen pick-up but potentially also reduce the oxygen level of the processed material. Some materials are more likely to benefit from this effect than other, such as iron for example.

### One Example of Intended Use

In the current example, the embodiment shown in FIG. 1 was tested, using the heating zone configuration shown in FIG. 7A, with a length of 4 inches. The powder feeder used was a commercial Mark XV powder feeder, which uses a rotating feed screw and a carrier gas to feed the powder into the apparatus. The powder was fed at a rate of 0.65 kg/h of angular Ti—6Al—4V alloy, although in other experiments, a feed rate as high as 1 kg/h was carried out with relatively similar results.

The plasma source was a DC arc plasma torch, with reversed polarity for higher voltage, operated at 50 kW. The plasma gas was argon fed at 230 slpm.

The appearance of the powder feedstock is shown in FIG. 4A and its particle size distribution is shown in FIG. 6A.

The appearance of the powder post processing is shown in FIG. 4B and FIG. 5, while its particle size distribution is shown in FIG. 6B.

In other examples, all using the general embodiment of FIG. 1, but with different heating zone configurations, oxygen pick up was studied. Table 1 compiles the oxygen content of the powder before and after processing for three different tests. Although not necessarily relevant, it is necessary to mention that T-09 was conducted using the configuration shown in FIG. 7B, and the others were conducted using the configuration shown in FIG. 7C. From the results, one could conclude that it would be technically feasible to process the powder with less than 300 ppm of oxygen pick-up.

TABLE 1
Oxygen pick-up during processing for 3 tests

| Test | O₂ pick-up (ppm) |
|---|---|
| T-09 | 279 |
| T-12 | 288 |
| T-15 | 233 |

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the embodiments and non-limiting, and it will be understood by persons skilled in the art that other variants and modifications may be made without departing from the scope of the embodiments as defined in the claims appended hereto.

### REFERENCES

[1] Peter G. Tsantrizos, Francois Allaire and Majid Entezarian, “Method of Production of Metal and Ceramic Powders by Plasma Atomization”, U.S. Pat. No. 5,707,419, Jan. 13, 1998.
[2] Christopher Alex Dorval Dion, William Kreklewetz and Pierre Carabin, “Plasma Apparatus for the Production of High Quality Spherical Powders at High Capacity”, International Patent Publication No. WO 2016/191854 A1, Dec. 8, 2016.
[3] “Method for Cost-Effective Production of Ultrafine Spherical Powders at Large Scale Using Plasma-Thrust Pulverization”, unpublished.
[4] Maher I. Boulos, Jerzy W. Jurewicz and Alexandre Auger, “Process and Apparatus for Producing Powder Particles by Atomization of a Feed Material in the Form of an Elongated Member”, U.S. Pat. No. 9,718,131 B2, Aug. 1, 2017.
[5] Maher I. Boulos, Jerzy Jurewicz Jiayin Guo, Xiaobao Fan and Nicolas Dignard, “Plasma Synthesis of Nanopowders”, United States Patent Application Publication No. US 2007/0221635 A1, Sep. 27, 2007.
[6] Maher I. Boulos, Christine Nessim, Christian Normand and Jerzy Jurewicz, “Process for the Synthesis, Separation and Purification of Powder Materials”, U.S. Pat. No. 7,572,315 B2, Aug. 11, 2009.

1. A process for spheroidizing and/or atomizing particles that are coarse and/or angular into spherical and fine particles.

2. The process as defined in claim 1, comprising:
a heating source;
a heating chamber;
a supersonic nozzle; and
a gas-solid separation system to collect the powder from the gas stream.

3. The process as defined in any one of claims 1 and 2, wherein the heating source includes a plasma torch.

4. The process as defined in any one of claims 1, 2 and 3, wherein the heating source is one or more DC or AC arc plasma torch(es), or a combination thereof.

5. The process as defined in any one of claims 1 to 4, wherein a powder feedstock is fed into the heating chamber with any injection angle.

6. The process as defined in any one of claims 1 to 5, wherein the processed powder is collected continuously or semi-continuously at the gas-solid separation stage.

7. The process as defined in any one of claims 1 to 5, wherein an inert gas is fed to avoid further oxidation of the material.

8. The process as defined in any one of claims 1 to 5, wherein a reducing gas is fed to reduce the oxidation layer of the material.

9. The process as defined in any one of claims 1 to 5, wherein an oxidizing gas is fed to add a layer of oxidation to the material.

10. The process as defined in any one of claims 1 to 5, wherein any combination of the gases mentioned in claims 6 to 8 are used to modify the surface or the chemical composition of the processed material.

11. The process as defined in any one of claims 1 and 2, wherein the supersonic nozzle is a convergent-divergent De Laval, adapted to reach a Mach number of 1 at a throat thereof.

12. The process as defined in claim 10, wherein the nozzle also has a diffuser at an end thereof to re-increase the temperature of the exiting jet and slow down the particle before it enters the cooling chamber.

13. The process as defined in any one of claims 1 and 2, wherein the supersonic nozzle design is one of a De Laval nozzle and an aerospike nozzle.

14. The process as defined in claim 1, wherein the impurities such as organic matter (grease, oil, fat, paper, rubber and plastics, etc.) and or humidity are adapted to be removed from the powder feedstock due to chemical degradation and evaporation at high temperature.

15. A process for spheroidizing and/or atomizing feedstock particles that are coarse and/or angular into spherical and fine particles, comprising: a) heating the feedstock particles, b) having the particles go through a supersonic nozzle, and c) collecting from the gas stream a so-produced powder, for instance with a gas-solid separation system.

16. An apparatus process for spheroidizing and/or atomizing feedstock particles that are coarse and/or angular into spherical and fine particles, comprising:
a heating source;
a heating chamber for melting the feedstock particles;
a supersonic nozzle; and
a gas-solid separation system to collect a powder from a gas stream exiting the supersonic nozzle.
